(19) United States
(12) Patent Application Publication
(10) Pub. No.: US 2016/0297282 A1
(43) Pub. Date: Oct. 13, 2016

(54) HVAC HEAT EXCHANGER AIR SEAL

(71) Applicant: DENSO International America, Inc., Southfield, MI (US)

(72) Inventor: William Morris, Beverly Hills, MI (US)

(21) Appl. No.: 14/683,704

(22) Filed: Apr. 10, 2015

(51) Int. Cl. B60H 1/00

(52) U.S. Cl. CPC B60H 1/00557

(57) ABSTRACT

An HVAC module includes an evaporator and a heater core housed in a HVAC casing. The HVAC casing has an opening wherein a heat exchanger is inserted into the opening. The case may have a tongue portion extending external of the case. The heat exchanger may have an insert with grooves that engage the tongue portions to act as an air seal for the heat exchanger.

### FIELD

This present disclosure relates to the field of automotive heating ventilation and air conditioning (HVAC), sealing of the heat exchangers to the HVAC case.

### BACKGROUND

This section provides background information related to the present disclosure which is not necessarily prior art.

Conventionally, in a vehicle HVAC the evaporator and heater core may be inserted into the HVAC case through an opening formed in the case. Sealing the opening with one of the heat exchangers inside may be important for maintaining proper air flow target and also the reduction of noise in the vehicle cabin. The opening for receiving the evaporator or heater core may be closed by a cover after the heater core has been installed in the HVAC case. This cover may be an additional component that may require additional fasteners to couple the cover to the HVAC case. Additionally, foam wrap or foam tape, also known as mastic may be used to create a seal between the evaporator or heater core and opening in the HVAC case. The foam seal generally is wrapped around the one of the heat exchangers by hand before being inserted into the HVAC case. Thus adding cost, complexity and inconsistency into the production process.

### SUMMARY

This section provides a general summary of the disclosure, and is not a comprehensive disclosure of its full scope or all of its features.

A vehicle HVAC module that may comprise an HVAC case that may have a heat exchanger. The heat exchanger may be installable inside the HVAC case through an opening that may be in a sidewall of the HVAC case. A plurality of grooves may extend from the heat exchanger. A plurality of tongue portions may extend from an external surface of the sidewall of the HVAC module. The tongue portion may internally engage the grooves.

Another embodiment may be a seal for a heat exchanger in an HVAC module. The embodiment may comprise an HVAC module having an external surface and an interior surface defining a channel for air to flow therethrough. A heat exchanger may be disposed in said channel of the HVAC module. A plurality of tongue portions may be extending perpendicular from the external surface for sealing the heat exchanger to the HVAC module. The heat exchanger may further comprise an insert with a plurality of grooves configured to engage the tongue portions.

Yet another embodiment may be a HVAC module with a HVAC case with a rectangular opening in a sidewall of the case. Additionally, a rectangular heat exchanger inserted into the opening. The heat exchanger may have an end plate assembled to the heat exchanger remaining external to the opening with groove portions generally extending beyond the width of the opening. Also, a plurality of tongue portions may extend from the sidewall spanning parallel of the length of the opening. The tongue portions may insertably engage the groove portions of the heat exchanger end plate.

Further areas of applicability of the present invention will become apparent from the detailed description provided hereinafter. It should be understood that the detailed description and specific examples, while indicating the preferred embodiment of the invention, are intended for purposes of illustration only and are not intended to limit the scope of the invention.

### DRAWINGS

The drawings described herein are for illustrative purposes only of selected embodiments and not all possible implementations, and are not intended to limit the scope of the present disclosure.

FIG. 1 is a schematic representation of a vehicle having a HVAC system;

FIG. 2 is a representation of interior of a vehicle;

FIG. 3 is diagram of a HVAC system;

FIG. 4 is a view of a heat exchanger installed into a HVAC module;

FIG. 5 is a cross section view of a heat exchanger installed into a HVAC module;

FIG. 6 is a representation of an embodiment a heat exchanger installed into a HVAC module.

FIG. 7 is a cross section view of a heat exchanger installed into a HVAC module; and

FIG. 8 is a exploded view a locking feature for a heat exchanger installed into a HVAC module.

Corresponding reference numerals indicate corresponding parts throughout the several views of the drawings.

### DETAILED DESCRIPTION

Example embodiments will now be described more fully with reference to the accompanying drawings. The following description is merely exemplary in nature and is not intended to limit the present disclosure, application, or uses. It should be understood that throughout the drawings, corresponding reference numerals indicate like or corresponding parts and features.

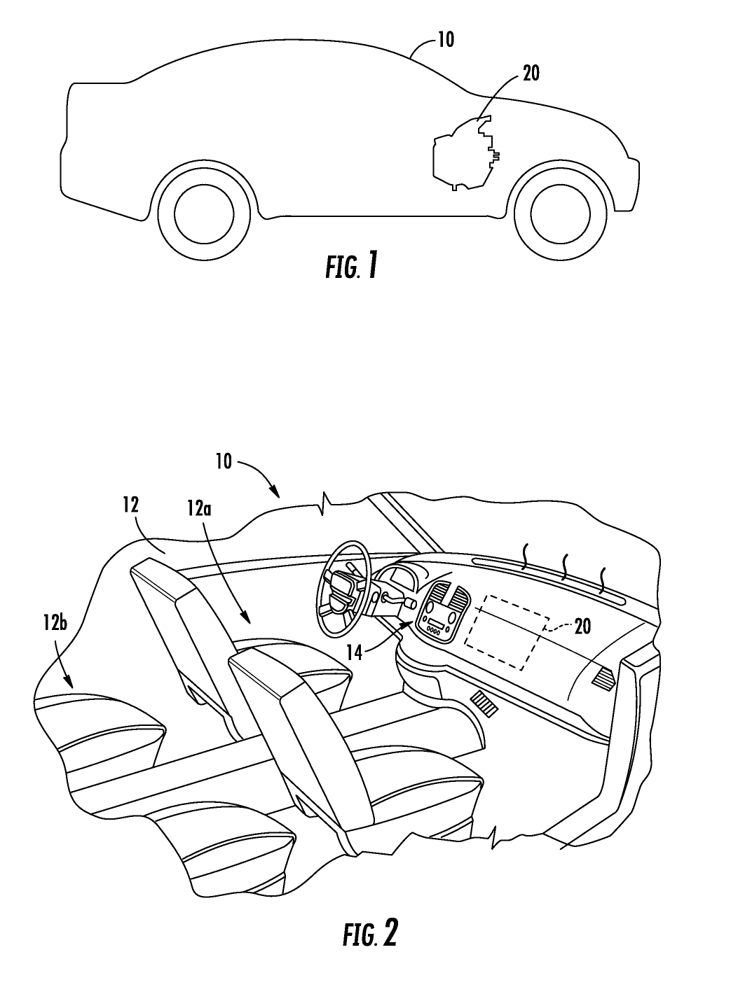

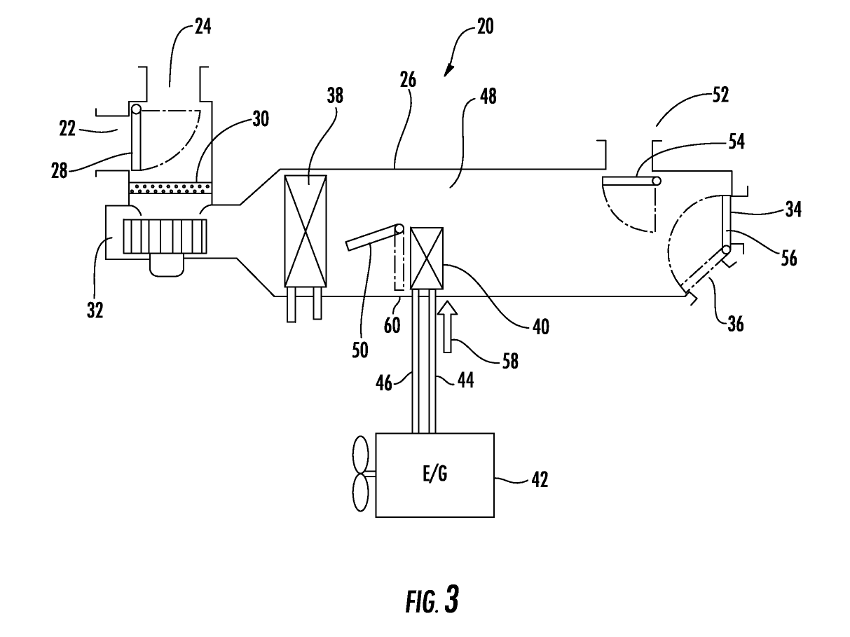

Referring to FIGS. 1 & 2, an automotive vehicle 10 with an HVAC module 20, also known as an air conditioner module, according to the present teachings can be utilized is shown. Vehicle 10 includes a passenger space 12 which may have both a front passenger space 12a and a rear passenger space 12b. HVAC controls 14 allow adjustment of the operation of HVAC module 20 to provide desired flows of conditioned air.

With reference to FIG. 3 is a general schematic view of the HVAC module 20. Note that the shapes in the schematic illustration in FIG. 3 may be different from actual shapes. There is an inside air inlet 22 to let inside air come into the compartment and an outside air inlet 24 to let in outside air at the upstream side of an HVAC casing 26, which forms an air flow path. It is known in the art that the HVAC casing 26 may be molded from any polymer by way of non-limiting example. There is also an inside/outside air switching door 28 that selectively opens and closes these inlets 22 and 24. A filter 30 that may remove dust from the air and a blower 32 may also be provided on the downstream side of the inlets 22 and 24. The air from the blower 32 is drawn into the inlets 22, 24 and directed to flow toward outlets 34 to 36. An evaporator 38 serving as an air cooling heat exchanger may be on the downstream side of the blower 32. A heater core 40 that serves as an air heating heat exchanger may be on the downstream side of the evaporator 38. The heater core 40 heats the air from the engine 42 cooling water as a heat source. The engine 42 may be fluidly coupled to the heater core 40 through conduit 44 and 46, additionally heater core 40 and engine may be fluidly coupled to the engine cooling system (not shown).

The HVAC casing 26 has a bypass area 48 to let cool air bypass the heater core 40. On the air upstream side of the heater 40, there is an air mix door 50, also known as a blend air door that adjusts the ratio of the quantity of warm air through the heater 40 and the quantity of cool air through the bypass 48. The HVAC casing 26 may also contain a defrost outlet 52. The HVAC casing may also contain mode doors 54 and 56 to control which outlets 34, 36, 52 air is directed out of the HVAC module 20.

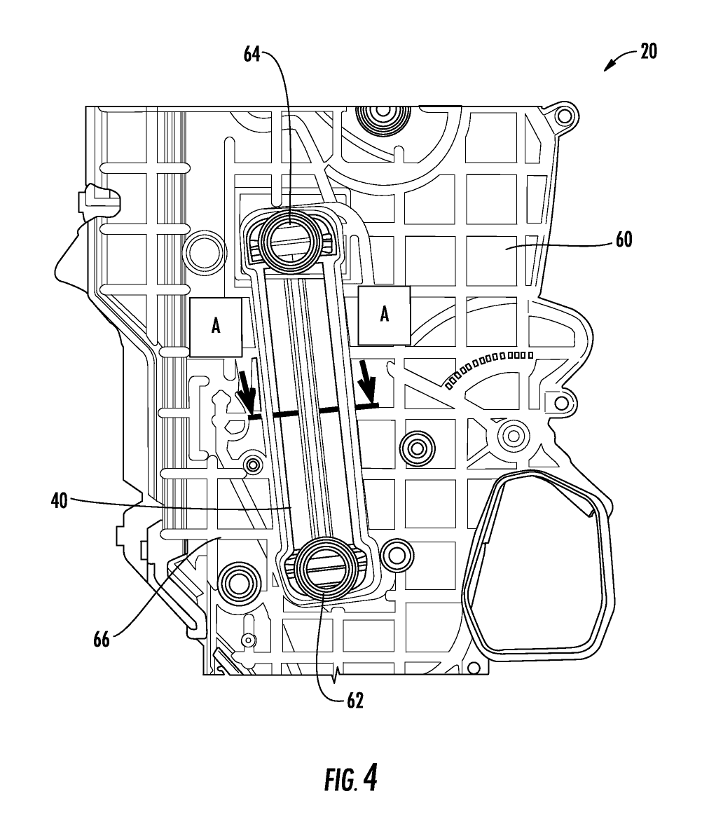

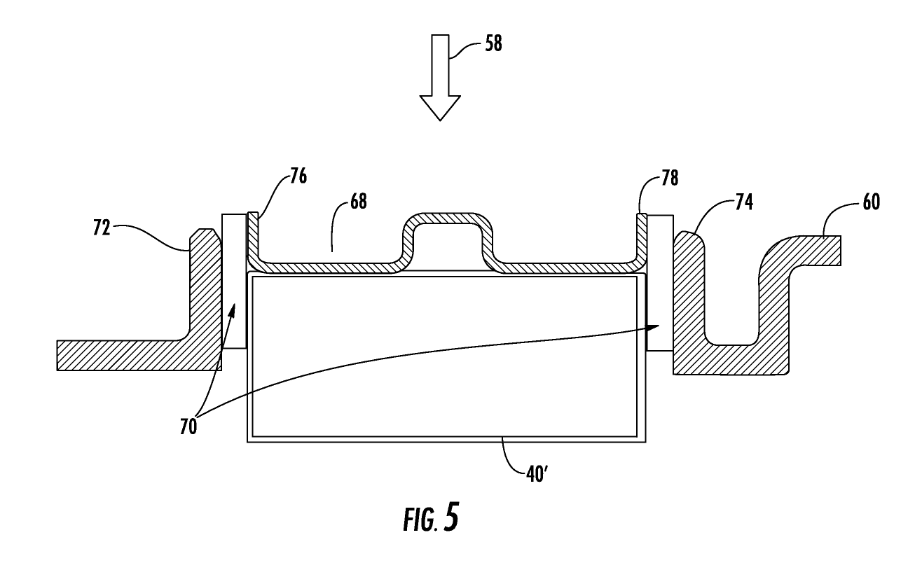

During assembly of the HVAC module 20 the heater core 40 is generally inserted, direction arrow 58, through the side wall 60 of the HVAC case 26. FIG. 4 displays the side wall 60 with the heater core 40 inserted into the HVAC module 20, through opening 66 in the case, the opening 66 may be generally rectangular in shape to match the shape of the heater core 40. The heater core 40 has an inlet 62 and outlet 64 that which conduits 44, 46 may be coupled. It is known in the art that the inlet 62 and outlet 64 may be fluidly coupled to an inlet tank and outlet tank respectively, both tanks not shown. It is also known in the art that the inlet and outlet tank are fluidly coupled by a core portion, not shown. One skilled in the art may also appreciate that inlet 62 and outlet 64 are shown on the opposite side of the heater core 40, however it is known in the art that both the inlet 62 and outlet 64 may be on one side of the heater core 40. The drawings shown are not intended to be limiting but merely an example of a possible configuration.

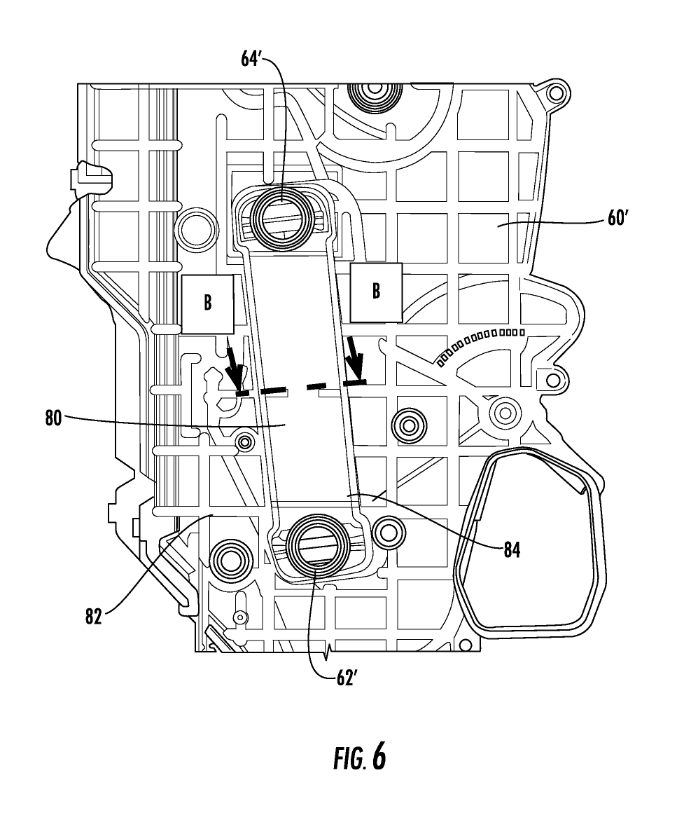

FIG. 5 displays a cross section A-A of opening 66 with heater core 40 inserted into the opening 66. Heater core 40 may also include an insert 68, also known in the art as an end plate, which generally may assist in containing the core portion (not shown) during assembly, add strength during the life of the heater core 40 and is a part of the heater core 40 assembly. The insert 68 may span from inlet 62 to outlet 64 and is generally the same material as the heater core. In a conventional assembly, heater core 40 is sealed against side wall 60 with foam packing 70. Side wall 60 includes sealing walls 72 and 74, which are generally parallel to insert direction 58 of the heater core 40 and perpendicular of the general side wall 60. Additionally the insert 68 will have sealing portions 76 and 78 that are parallel to the sealing walls 72 and 74 of the side wall 60. Foam packing 70 is in-between sealing walls 72, 74 and 76, 78 and prevents air leaking from around the heater core 40.

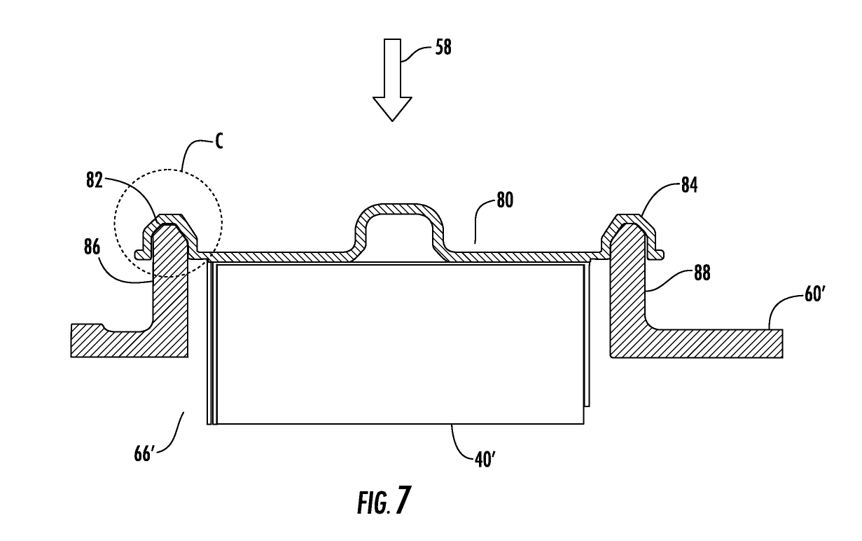

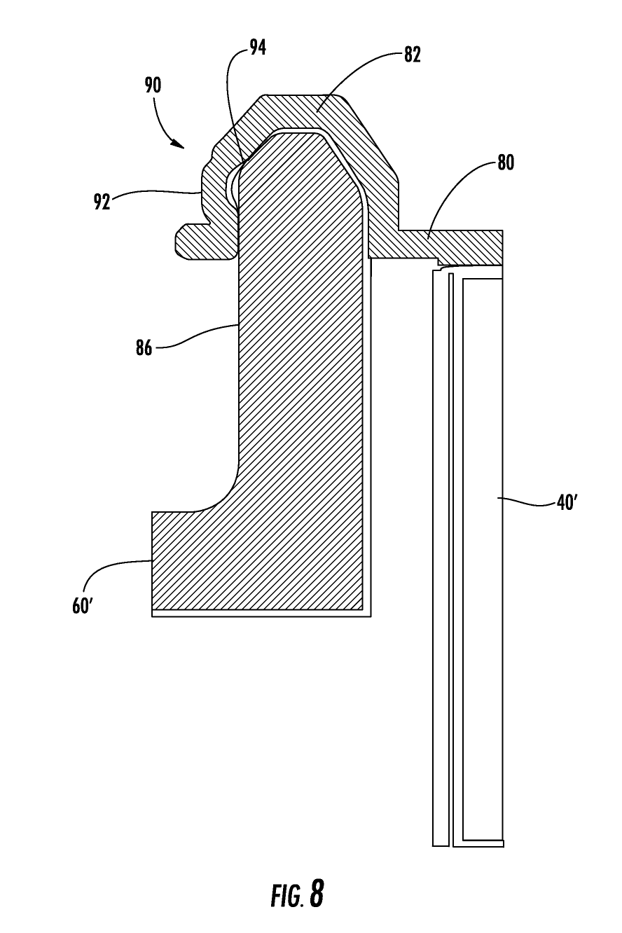

The present embodiment may be shown in FIG. 6 and FIG. 7, the latter which is a view of cross section B-B. The heater core 40′ may include an insert 80 that may act as a seal to side wall 60′. The assembly process of the present embodiment is the same as previously described wherein heater core 40′ is inserted into opening 66′ in direction of arrow 58. The insert 80 may include a first groove portion 82 and a second groove portion 84. Both first and second groove portion spans the length of the insert 80 from inlet 62′ to 64′ of the heater core 40′. The sidewall 60′ may include a first tongue portion 86 and second tongue portion 88 that engages the first and second groove portions 82, 84 of the heater core 40′. The tongue portions 86, 88 may be molded into the sidewall 66′. The insert 80 extending wider than opening 66′ to engage tongue portions 86, 88. The tongue portions 86, 88 may generally span the external length of the opening 66′ in the sidewall 60′ and may generally extend perpendicular to the sidewall 60′ and parallel to opening 66′. The connection of tongue 86, 88 in the groove portions 82, 84 may act as the air seal of the heater core 40′ to the side wall 60′ and may prevent the need to use any type of foam tape or wrapping seal. Potentially eliminating the foam seal may improve manufacturing efficiency and reduce costs and complexity. Additionally, the sealing portion of the tongues 86, 88 and grooves 82, 84 are outside the case and are verifiable in an assembly process.

It may be understood that the heater core 40′ may be further secured to the side wall 60′ by the tongue 86, 88 in the groove portions 82, 84. The thickness of the tongue 86, 88 may be slightly greater than the groove portions 82, 84 thus creating interference fit where the groove portions 82, 84 may pinch the tongue 86, 88 and may add added durability strength. Additionally, further locking mechanisms may be used in additional embodiments. FIG. 8 is a close up of the circle C from FIG. 7, which shows an embodiment of the tongue 86 and groove 82 in combination with a locking feature 90. The groove 82 may contain a channel portion 92; the channel portion 92 creates room and engages a lip portion 94 located on the tongue 86. The lip portion 94 may be molded into the tongue 86. The engagement of the channel 92 and lip 94 of the tongue 86 and groove 82 may act as a locking device to secure the heater core 40′ in the HVAC module 20.

It is understood in the art that the teachings provided may be utilized on a evaporator 38 located in the HVAC module 20 not limited to strictly the heater core 40. Those skilled in the art can now appreciate from the foregoing description that the broad teachings of the present invention can be implemented in a variety of forms. Therefore, while this invention has been described in connection with particular examples thereof, the true scope of the invention should not be so limited since other modifications will become apparent to the skilled practitioner upon a study of the drawings, the specification and the following claims.

The foregoing description of the embodiments has been provided for purposes of illustration and description. It is not intended to be exhaustive or to limit the invention. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the invention, and all such modifications are intended to be included within the scope of the invention.

What is claimed is:

1. A vehicle HVAC module, comprising:
a HVAC case;
a heat exchanger, installable inside the HVAC case through an opening in a sidewall of the HVAC case;
a plurality of grooves extending from the heat exchanger; and
a plurality of tongue portions extending from an external surface of the sidewall wherein the tongue portion internally engages the grooves.

2. A vehicle HVAC module according to claim 1 wherein the opening and the heat exchanger are generally rectangular in shape.

3. A vehicle HVAC module according to claim 2 wherein the plurality of tongue portions extend perpendicular to the sidewall and parallel to the rectangular opening.

4. A vehicle HVAC module according to claim 2 wherein the plurality of grooves span the length of the rectangular heat exchanger.

5. A vehicle HVAC module according to claim 1 wherein the heat exchanger further comprises an insert, the insert extending beyond the width of the opening in the sidewall, the plurality of grooves extending from the insert.

6. A vehicle HVAC module according to claim 1 wherein the plurality of grooves further comprise a channel that spans the length of the groove, the plurality of tongue portions further comprise a lip wherein the channel is configured to engage the lip as a locking feature.

7. A seal for a heat exchanger in an HVAC module comprising:
an HVAC module having an external surface and an interior surface defining a channel for air to flow therethrough;
a heat exchanger disposed in said channel of the HVAC module; and
a plurality of tongue portions extending perpendicular from the external surface for sealing the heat exchanger to the HVAC module wherein the heat exchanger further comprises an insert with a plurality of grooves configured to engage the tongue portions.

8. A seal for a heat exchanger in an HVAC module according to claim 7 wherein the opening and the heat exchanger are generally rectangular in shape and the insert is generally wider than the opening.

9. A seal for a heat exchanger in an HVAC module according to claim 8 wherein the plurality of tongue portions span parallel to the rectangular opening.

10. A seal for a heat exchanger in an HVAC module according to claim 9 wherein the groove portions span the length of the heat exchanger.

11. A seal for a heat exchanger in an HVAC module according to claim 7 wherein the heat exchanger is a heater core configured to heat air passing through the HVAC module.

12. A seal for a heat exchanger in an HVAC module according to claim 11 wherein the heater core is generally rectangular in shape and has an inlet on one end and an outlet on the opposite end and the insert spans between the inlet and outlet.

13. A seal for a heat exchanger in an HVAC module according to claim 12 wherein the plurality of grooves further comprise a channel that spans the length of the groove, the plurality of tongue portions further comprise a lip wherein the channel is configured to engage the lip as a locking feature.

14. A HVAC module comprising;
a HVAC case with a rectangular opening in a sidewall of the case;
a rectangular heat exchanger inserted into the opening,
an end plate assembled to the heat exchanger remaining external to the opening with groove portions generally extending beyond the width of the opening; and
a plurality of tongue portions extending from the sidewall spanning parallel of the length of the opening; wherein the tongue portions insertably engage the groove portions of the heat exchanger end plate.

15. A HVAC module according to claim 14 wherein the tongue portions are integrally molded into the HVAC case.

16. A HVAC module according to claim 15 wherein the plurality of tongue portions further comprises a lip that is molded into the tongue portion s and the grooves further comprise a channel that spans the length of the groove, wherein the channel is configured to engage the lip as a locking feature.

17. A HVAC module according to claim 14 wherein the exchanger is a heater core that has an inlet on one end and an outlet on the opposite end and the insert spans between the inlet and outlet.
